(19) United States
(12) Patent Application Publication
(10) Pub. No.: US 2004/0083467 A1
(43) Pub. Date: Apr. 29, 2004

(54) System and method for executing intermediate code

(75) Inventors: Mark G. Hanley, Skamania, WA (US); Ronald D. Braithwaite, Portland, OR (US)

Correspondence Address: David C. Ripma, Patent Counsel, Sharp Laboratories of America, Inc., 5750 NW Pacific Rim Boulevard, Camas, WA, 98607, US

(73) Assignee: Sharp Laboratories of America, Inc.

(21) Appl. No.: 10/283,724

(22) Filed: Oct. 29, 2002

(51) Int. Cl. G06F 9/45

(52) U.S. Cl. 717/148; 717/118

(57) ABSTRACT

A system and method are provided for efficiently executing intermediate code. The method comprises: receiving an application generated in an intermediate code such as JAVA, .NET, or VisualBasic; automatically compiling the intermediate code into native machine code; saving the native machine code in permanent memory; receiving a command to execute the application; accessing the native machine code from permanent memory; and, executing the application using the native machine code. Some aspects of the method further comprise: tagging the native machine code in permanent memory as a native machine code version of the application; and, in response to receiving a command to execute the application, checking the permanent memory for a native machine code version of the application. Then, accessing native machine code from permanent memory includes accessing native machine code if a native machine code version of the application is identified in permanent memory.

### BACKGROUND OF THE INVENTION

1. Field of the Invention

This invention generally relates to computer software and, more particularly, to a system and method for more efficiently executing an intermediate code, such as a Java language code, into a specific native machine code.

2. Description of the Related Art

As noted in U.S. Pat. No. 6,385,764 (Blandy et al.), Java is an object oriented programming language and environment focusing on defining data as objects and the methods that may be applied to those objects. “Java” is a trademark of Sun Microsystems, Inc. Java supports only a single inheritance, meaning that each class can inherit from only one other class at any given time. Java also allows for the creation of totally abstract classes known as interfaces, which allow the defining of methods that may be shared with several classes without regard for how other classes are handling the methods. Java provides a mechanism to distribute software to different computing platforms. The description of Java that follows is also applicable, at least generally, to other types of intermediate code.

Java is able to support applications for many types of data processing systems, which may contain a variety of central processing units and operating system architectures. The Java Virtual Machine (JVM) is a virtual computer component that resides only in memory. The JVM allows Java programs to be executed on different platforms as opposed to only the one platform for which the code was compiled. Java programs are compiled for the JVM. In this manner, Java is able to support applications for many types of data processing systems, which may contain a variety of central processing units and operating systems architectures. To enable a Java application to execute on different types of data processing systems, a compiler typically generates an architecture-neutral file format. The compiled code is executable on many processors, given the presence of the Java runtime system. The Java compiler generates byte code instructions that are non-specific to particular computer architectures. A byte code is a machine independent code generated by the Java compiler and executed by a Java interpreter. A Java interpreter is a module in the JVM that alternatively decodes and executes a byte code or byte codes. These byte code instructions are designed to be easy to interpret on any machine and easily translated on the fly into native machine code.

A development environment, such as the Java Development Kit (JDK), available from Sun Microsystems, Inc., may be used to build Java byte code from Java language source code and libraries. This Java byte code may be stored as a Java application or applet on a Web Server, where it can be downloaded over a network to a user's machine and executed on a local JVM.

When extra speed in executing a Java program is needed, a Just In Time (JIT) compiler may be used to translate byte codes for a method or class into native machine instructions before executing them. Typically, this compilation only occurs once per method. Some JIT compilers may compile entire classes, rather than one method at a time.

As noted in U.S. Pat. No. 6,295,643 (Brown et al.), while the Java language is designed to be platform-independent, and to execute primarily in a secure environment, programmers can extend Java applications through the use of compiled native binary code on the host operating system using C-style calling conventions through the Java Native Interface (JNI). In this fashion, a Java application can have complete access to the host operating system, including reading and writing to attached I/O devices, memory, etc. Because of this, Java programs can accomplish tasks that are not normally allowed via the JVM at the cost of being platform-specific. However, with a well-designed architecture, a Java language programmer can cleanly isolate the platform-independent portion, and present a clean, platform-independent object application programming interface (API) to other Java components while at the same time accomplishing platform-specific tasks.

To improve performance, without requiring the application developer to write performance sensitive code using a platform specific implementation accessed through JNI, a JVM may provide additional facilities including a Just-in-Time compiler (JIT). A JIT compiler creates platform native code in the address space of the Java Virtual Machine at runtime. Since the lifetime of the objects created with the JIT compiler is limited to the lifetime of the application execution within the Java Virtual Machine, and the objects are always created from the platform independent byte codes, the use of a JIT compiler does not make the application platform specific.

The JIT compiler operates as an extension of the JVM. When the JVM encounters a method that has not been compiled by the JIT compiler (JITed), it may call the JIT compiler to create the native runtime objects. Subsequent executions of the method will be executed using the JIT compile code. Typically, the JITed code executes many times faster than the interpreted byte code.

However, the use of a JIT compiler requires time to create the native runtime objects each time the application is executed. Additional memory for the JIT compile program code and its runtime memory consumption is also needed. As a result, the JIT compile process can often consume a significant amount of processing time in the operation of an application. This real time constraint may limit the number, or aggressiveness, of optimizations that the JIT compiler can attempt to generate native runtime objects that deliver optimal performance.

Microsoft has also released an intermediate code language that is called Microsoft intermediate language (MSIL) or .NET. It is noted (http://msdn.microsoft.com/library/default.asp?url=/library/enus/dndotnet/html/dotnetperftechs.asp) that as with any virtual machine (VM), the common language runtime (CLR) needs a way to compile the intermediate language down to native code. When compiling a program to run in the CLR, the compiler takes the source from a high-level language down to a combination of MSIL (Microsoft Intermediate Language) and metadata. These are merged into a PE file, which can then be executed on any CLR-capable machine. When this executable is run, the JIT starts compiling the intermediate language (IL) down to native code, and executes that code on the real machine. This is done on a per-method basis, so the delay for JITing is only as long as needed for the code that is run.

For an application vendor, the ability to precompile code during installation is an attractive option. Microsoft does provide this option in the form ngen.exe, which permits a vendor to run the normal JIT compiler over their whole program once, and save the result. Since the run time-only optimizations cannot be performed during precompilation, the code generated is not usually as good as that generated by a normal JIT. However, without having to JIT methods on the fly, the startup cost is much lower, and some programs will launch noticeably faster. In the future, ngen.exe may do more than simply run the same run time JIT: more aggressive optimizations with higher bounds than the run time, load-order-optimization exposure to developers (optimizing the way code is packed into VM pages), and more complex, time consuming optimizations that can take advantage of the time during precompilation.

Cutting the startup time helps in two cases. The first situation is when an enormous number of methods are called early on in your program, resulting in an unacceptable load time. Precompiling also makes sense in the case of large shared libraries. Microsoft precompiles the Frameworks for the CLR, since most applications will use them.

It should be noted, however, that the Microsoft .NET technique uses a JIT compiler to precompile a limited number of files, but that generation of the true native code is a separate step that is done by the developer as part of the development process. The generation of native machine code is not automatically accomplished when the application is loaded into the system.

Applications that use an intermediate code, such as Java byte code, suffer performance penalties compared with their native machine code counterparts. This is due to either the constant reinterpretation of the byte code by the Virtual Machine during execution, or to the initial correlation of the byte code into machine code by a Just-In-Time compiler. It should be noted that once compiled, the resulting translation can perform with little, if any, performance penalty.

It is desirable for an intermediate code application to be executable on multiple and differing hardware and software environments. However, since the applications are distributed via the Internet, a local area network, or on removable media, the specific hardware and software platforms are unknown and cannot be presumed. Compilers must always produce machine specific code for the specific hardware and software platforms.

Conventionally, such compilations are not saved, and a costly recompile must occur every time the application is executed. Alternately, the compilations are targeted for a particular hardware and software configuration and are stored as such on fixed or removable media. The targeted nature of these compiled files is necessary to guarantee the compatibility with the specific hardware and software environment while maintaining satisfactory application startup times.

Neither of the above-mentioned compilation processes addresses the generation of machine-optimized code that might be moved to a different hardware or software environment for execution. Each subsequent execution of intermediate code requires a re-compilation, while machine-optimized code cannot be executed on a substantially different hardware and software environment.

It would be advantageous if intermediate code could be compiled for just the initial execution of an application, and the compiled native machine code saved for subsequent execution.

It would be advantageous if an entire intermediate code application could be compiled and saved as native machine code.

It would be advantageous if the above-mentioned saved native machine code could be recompiled when errors were detected in the native machine code, or when a different native machine code was required.

### SUMMARY OF THE INVENTION

The present invention addresses the performance penalty experienced by applications using intermediate code, such as Java or .NET, that must be compiled into native code. The present invention discloses a method of saving and reusing these machine-optimized translations, bypassing the overhead of all but the initial compilation, while retaining the obvious advantages of a portable intermediate code.

Accordingly, a method is provided for efficiently executing intermediate code. The method comprises: receiving an application generated in an intermediate code such as JAVA, .NET, or VisualBasic; automatically compiling the intermediate code into native machine code; saving the native machine code in permanent memory; receiving a command to execute the application; accessing the native machine code from permanent memory; and, executing the application using the native machine code.

In some aspects, where the application is received in a first machine environment, the method further comprises: tagging the native machine code in permanent memory as a first machine environment native machine code version of the application; and, in response to receiving a command to execute the application in a first machine environment, checking the permanent memory for a first machine environment native machine code version of the application. Then, accessing native machine code from permanent memory includes accessing native machine code if a first machine environment native machine code version of the application is identified in permanent memory.

Additional details of the above-described method and a system for efficiently executing intermediate code are presented below.

### BRIEF DESCRIPTION OF THE DRAWINGS

FIGS. 1a and 1b are schematic block diagrams of the present invention system for efficiently executing intermediate code.

FIG. 2 is a flowchart illustrating aspects of the present invention method.

FIGS. 3a through 3c are flowcharts illustrating the present invention method for efficiently executing intermediate code.

### DETAILED DESCRIPTION OF THE PREFERRED EMBODIMENTS

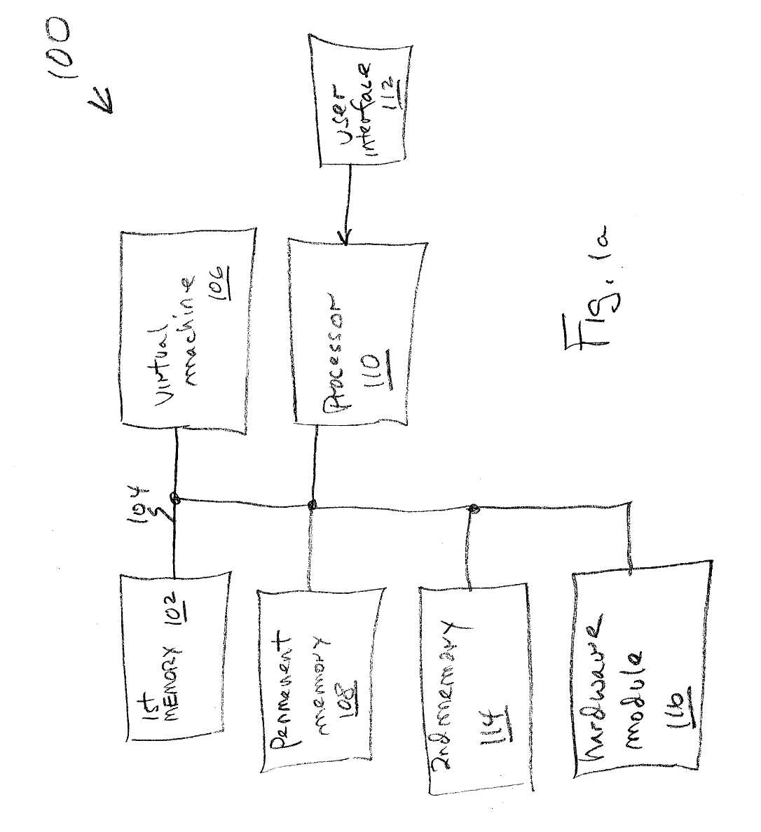

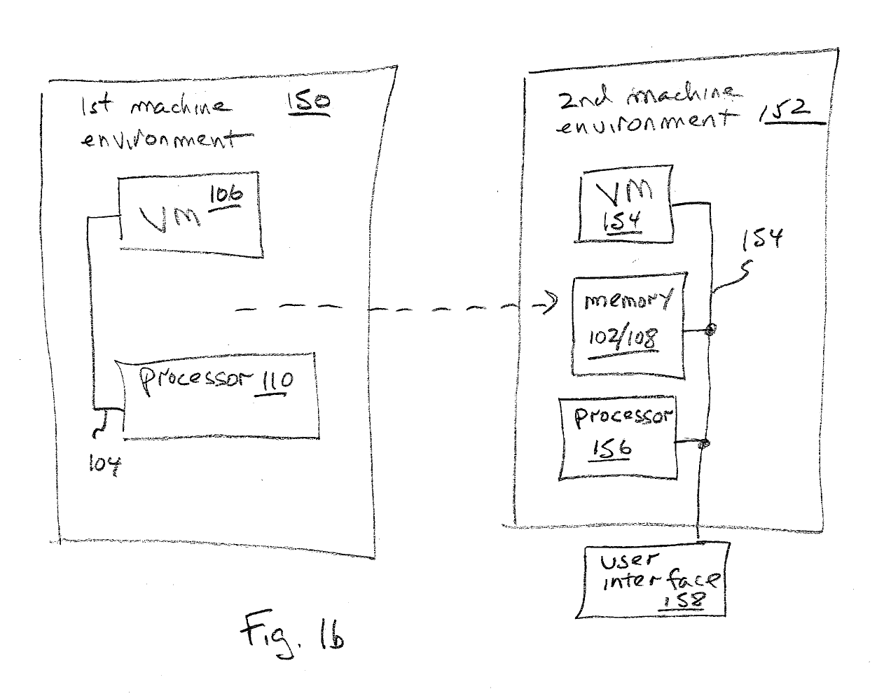

FIGS. 1a and 1b are schematic block diagrams of the present invention system for efficiently executing intermediate code. In FIG. 1a, the system 100 comprises a first memory 102 having an interface on line 104 to receive an application that has been generated in an intermediate code such as JAVA, .NET, or VisualBasic. However, it should be understood that these intermediate code types are merely listed as examples. The present invention is not limited to any particular type of intermediate code or method of code delivery. A virtual machine 106 has an interface on line 104 to accept the intermediate code application from the first memory 102 and compile the intermediate code into native machine code. For example, if the first memory 102 receives an application written in JAVA, then the virtual machine 106 is a just-in-time (JIT) JAVA virtual machine to compile the JAVA code into native machine code. In some aspects, the compilation is done upon loading. In other aspects the compilation is performed when the application is initially executed.

In some aspects, the line 104 represents a conventional address/data bus. Alternately, the above-described elements may be connected independently. A permanent memory 108 has an interface on line 104 connected to the virtual machine 106 to save the native machine code. In some aspects, the first memory 102 and the permanent memory 108 are the same (common) memory. The permanent memory 108 can be FLASH, hard drive, EEPROM, or a removable drive, such as a ZIP drive. However, the invention can be enabled with other types of conventional memory not specifically listed above. In one aspect, the system 100 is a television of other electronic consumer product.

A processor 110 has a user interface 112 to receive a command to execute the application. Note that is some aspects, the command to execute may come from alternate sources. For example, the command may be called from the execution of another application (not shown). The processor 110 accesses native machine code from the permanent memory 108 and executes the application using the native machine code. Alternately, it could be stated that a controlling program (not shown) uses the processor 110 to execute the application. Note that the native machine code is compiled to work with a specific type of processor. The various types of processors available are too numerous to mention and are well known by those skilled in the art. Also note that after the initial compilation by the virtual machine 106, the processor 110 need only access the permanent memory to access code that it can execute. That is, the intermediate code in the first memory 102 need not be compiled for subsequent executions by the processor 110.

In some aspects of the system 100, the processor 110 is a first machine environment processor, where the first machine environment is defined by the specific processor type and/or the operating system in which the processor is used. Then, the virtual machine 106 compiles the intermediate code into a first machine environment native machine code of the application.

In some aspects of the system 100, the permanent memory 108 accepts tagged first machine environment native machine code version of the application. Then the processor 110, in response to receiving a command to execute the application, checks the permanent memory 108 for a first machine environment native machine code version of the application. If a first machine environment native machine code version of the application is identified in permanent memory 108, the processor 110 accesses the permanent memory 108.

The present invention is able to make allowance for native machine code that becomes corrupted or updated. In some aspects, the processor 110 checks permanent memory 108 for the existence of application metadata associated with the native machine code version of the application, and checks the integrity of the metadata. Metadata is considered to be data that describes other data. That is, the metadata may describe the source of the data, compiling particulars, and data formats. If the integrity check of the metadata fails, the virtual machine 106 recompiles the intermediate code into native machine code and the processor 110 executes the recompiled native machine code version of the application. The processor 110 can check for metadata in sources such as metadata files, intermediate code files, or in a metadata registry. Typically, these sources are all located in permanent memory 108.

Typically, the virtual machine 106 saves the recompiled native machine code as a bundle in proximately located sections of permanent memory 108. It is also typical the processor 110 deletes associated executable (EXE) files in permanent memory, if the integrity check of the metadata fails. More specifically, the processor 110 checks that all the files listed as required by the metadata are present in permanent memory 108. If any of the required files are missing, the processor 110 deletes any EXE files in permanent memory 108 associated with the metadata.

In some aspects of the system 100, the processor 110 checks that files listed as required by the metadata include a signature that matches the metadata signature. If a non-matching signature is found, the processor 110 deletes any EXE files in permanent memory 108 associated with the metadata.

Some aspects of the system 100 further comprise a second memory 114 including software, with a software identifier, required by the processor 110 to perform the application. Note that is some aspects of the system 100, the second memory 114 is part of the first memory 102 or the permanent memory 108. Alternately, or in addition to the second memory 114, the system 100 may include a hardware module 116 with a hardware identifier required by the processor 110 to perform the application. The processor 110 checks that the unique identifier (UID) associated with the metadata in permanent memory 108 is consistent with the hardware and software identifiers.

In some aspects, the processor 110 generates EXE files from the metadata in permanent memory 108, checks the integrity of the EXE files, updates the metadata to reflect the generated EXE files, and checks the integrity of the updated metadata. The processor 110 may also delete any associated EXE file in permanent memory 108 if the integrity check of the updated metadata fails.

In FIG. 1b the present invention system for efficiently executing intermediate code is depicted using two different machine environments. The first machine environment 150 is the same as the description of the system of FIG. 1a. Note however, that the first memory 102 and the permanent memory 108 are a common memory. A second machine environment 152 includes a virtual machine (VM) 154 having an interface on line 154 for accepting the intermediate code application from the first memory 102 and recompiling the intermediate code into a second machine environment native machine code. The permanent memory 108 has an interface connected to the virtual machine 154 to save the second machine environment native machine code. A processor 156 has a user interface 158 to receive a command to execute the application. The processor 156 accesses second machine environment native machine code from the permanent memory 108 and executes the application using the second machine environment native machine code.

As shown, the figure illustrates a scenario where the memory 102/108 of a first electronic device machine environment 150 is loaded into a second electronic machine environment 152 that uses a different processor 156 and/or operating system than the first environment processor 110. Once the second machine environment 152 determines that the application cannot be run using the native machine code currently in memory, it recompiles the intermediate code into the second machine environment native machine code. The recompiled native machine code can then be used to execute the application and it can be saved in memory for subsequent executions.

In other scenarios not shown, the second machine environment 152 may be linked to the first machine environment 150 via a local area network LAN or Internet connection for example. The second machine environment 152 seeks second machine environment native machine code in the first machine environment memory. If that version of native machine code is not found, the second machine environment recompiles the intermediate code into second machine environment native machine code, so that it can execute an application. The second machine environment 152 can save the second machine environment native machine code in the permanent memory of the first machine environment 150 or in its own permanent memory.

### Functional Description

The present invention describes a process whose goal is to always allow the execution of machine-specific binary executable code from machine independent (intermediate) code. The present invention assumes the existence of a controlling program, such as an operating system, which only attempts to execute applications known to exist with no known errors.

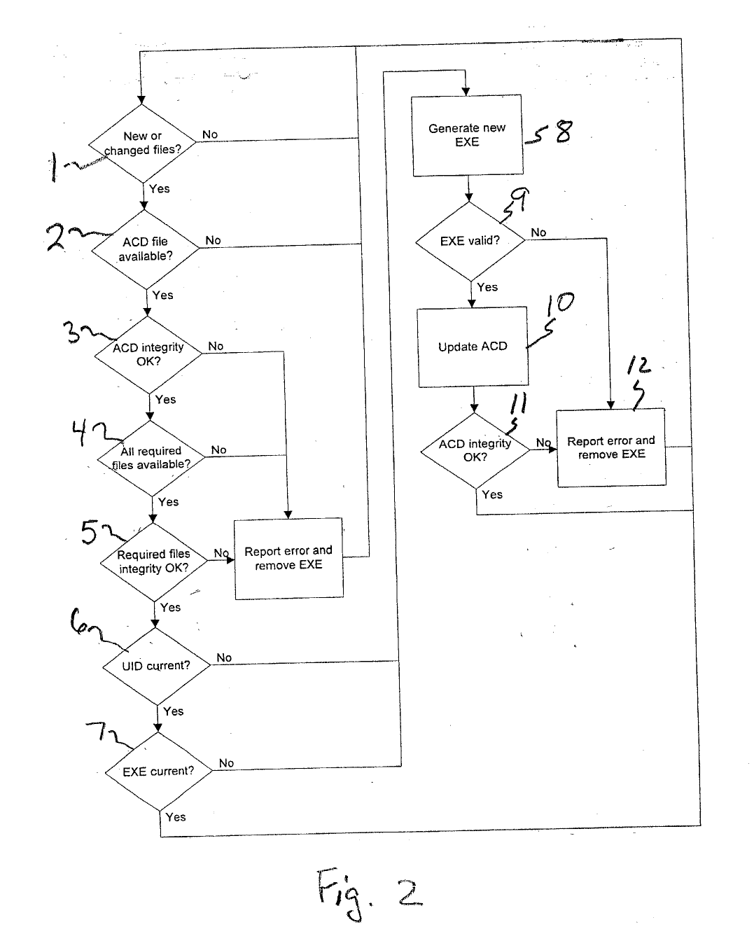

FIG. 2 is a flowchart illustrating aspects of the present invention method. The method generally follows these steps:

1. Detect any new or modified files within a specified directory hierarchy of a file system;

2. Check for the existence of application metadata. If there are is no metadata, return to Step 1. In some aspects, as shown in the figure for example, the metadata can be an application configuration data (ACD) file. However, as stated above, the metadata need not be in a separate ACD file. The metadata can be in the intermediate code file itself, or in a registry such as Microsoft Windows;

3. Check the integrity of each ACD file. If the integrity check of an ACD fails, delete any binary exec table (EXE) file specified by the ACD file, report the error to the controlling program, and return to Step 1;

4. Check that all files listed as required by an ACD file are available. If any of the required files are missing, delete any EXE file associated with the ACD file, report the error to the controlling program, and return to Step 1;

5. Check that each of the required files has a signature that matches a signature in the ACD file. If any of the required files fails the integrity check, delete any EXE file associated with the ACD file, report the error to the controlling program, and return to Step 1;

6. Check that the Unique Identifier (UID) found in the ACD file is consistent with the hardware and software environment. If the UID is not consistent, delete any EXE file associated with the ACD file, report the error to the controlling program, and go to Step 8;

7. Check that any EXE file associated with an ACD file matches its signature in the ACD file. If it does not match, delete any EXE associated with the ACD file, report the error to the controlling program, and go to Step 8. Else, go to Step 1;

8. Generate the EXE files associated with the ACD file;

9. Check the integrity of the generated EXE files. If any of the EXE files fail the integrity check, delete the EXE files, report the error to the controlling program, and return to Step 1;

10. Update the ACD file to reflect the new EXE files;

11. Check the integrity of the ACD file. If the integrity check of the ACD fails, delete any EXE file specified by the ACD file, report the error to the controlling program, and return to Step 1; and,

12. Report the existence of the application represented by the updated EXE and ACD files to the controlling program and go to Step 1.

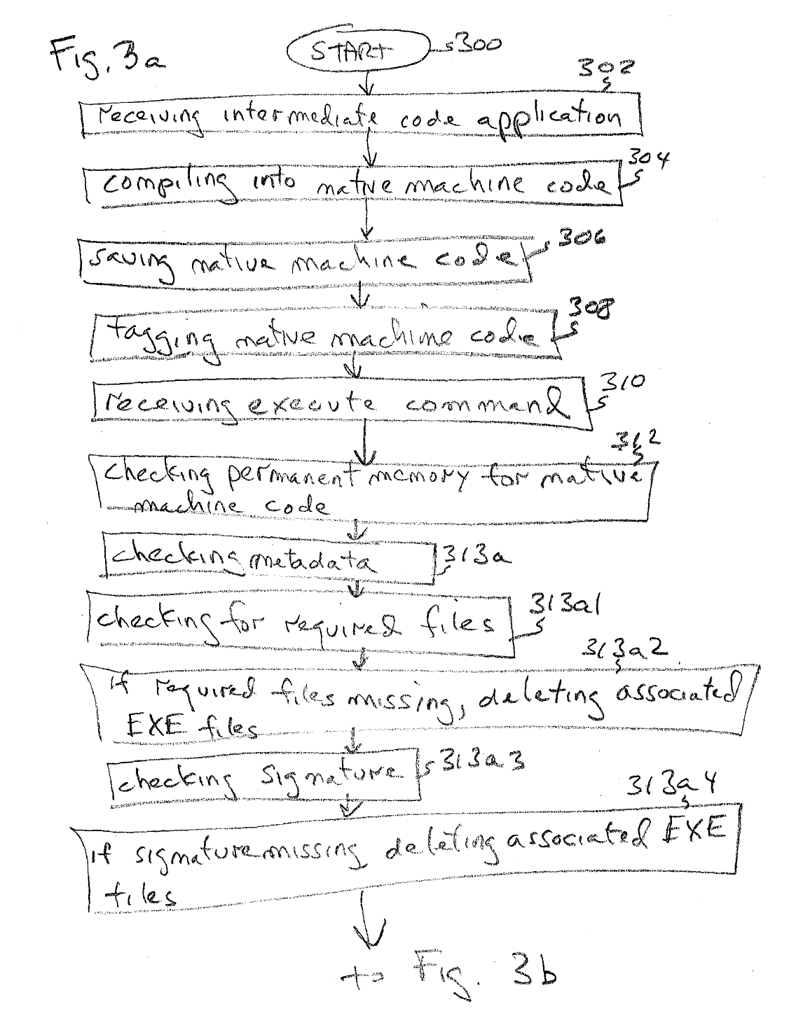

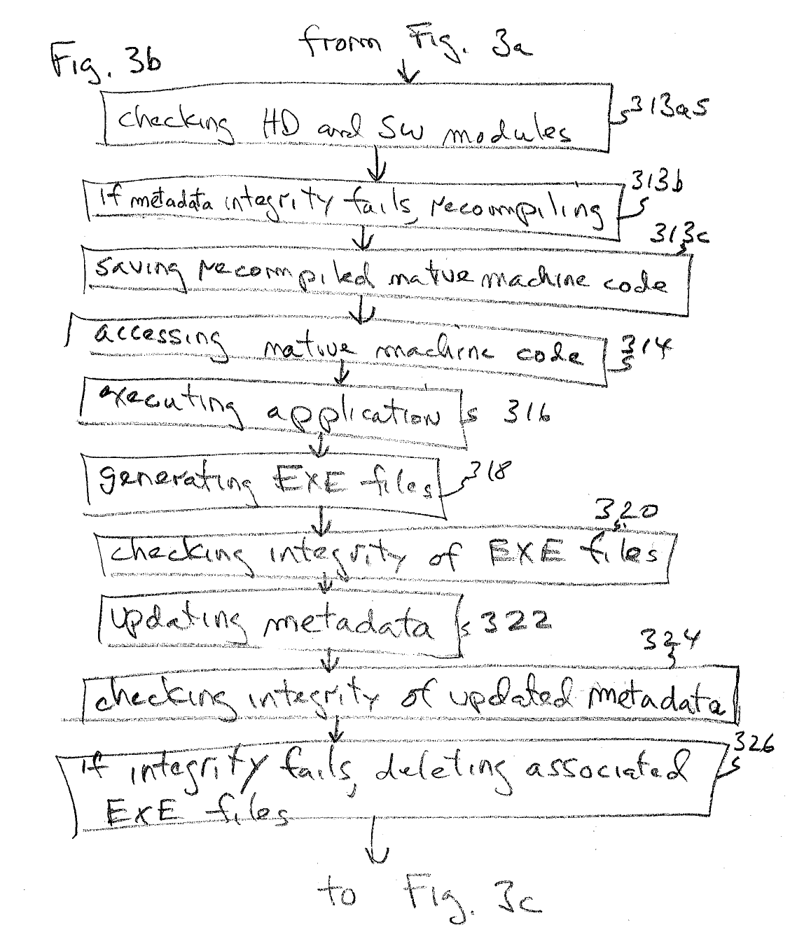

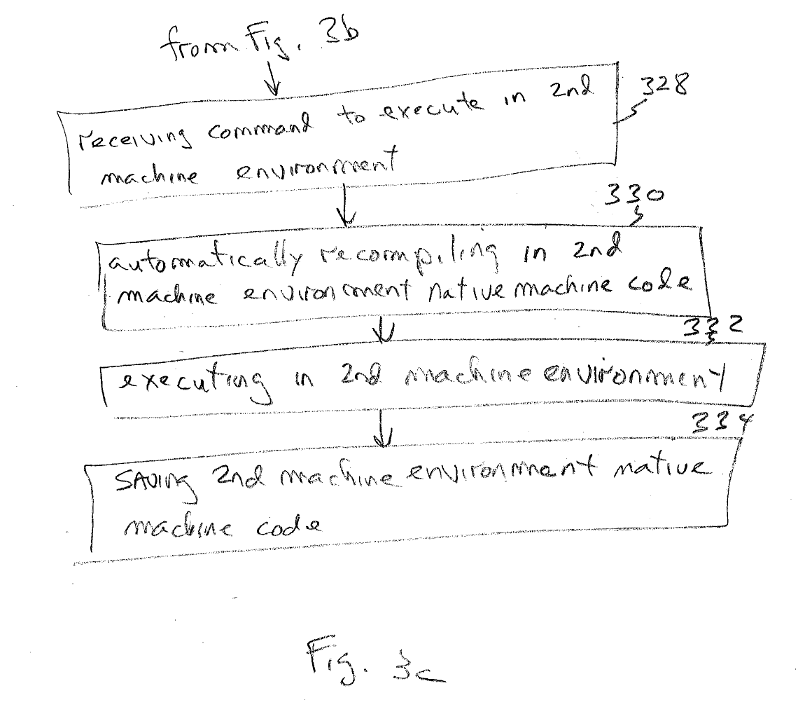

FIGS. 3a through 3c are flowcharts illustrating the present invention method for efficiently executing intermediate code. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 300.

Step 302 receives an application generated in an intermediate code. For example, JAVA, .NET, or VisualBasic applications can be received. Note that the method is not dependent upon to manner in which the application is received. Step 304 automatically compiles the intermediate code into native machine code. Step 306 saves the native machine code in permanent memory. Step 310 receives a command to execute the application. Step 314 accesses the native machine code from permanent memory such as FLASH, hard drive, EEPROM, or removable drives. In some aspects, accessing native machine code from permanent memory includes accessing native machine code if a native machine code version of the application is identified in permanent memory. Step 316 executes the application using the native machine code.

In some aspects of the method, automatically compiling the intermediate code into native machine code in Step 304 includes compiling the intermediate code into a native machine code for a first machine environment. Receiving a command to execute the application in Step 310 includes receiving a command to execute the application in the first machine environment. Then, executing the application using the native machine code in Step 316 includes executing the application using the first machine environment native machine code.

In some aspects, receiving an application in an intermediate code in Step 302 includes receiving an application in a first machine environment. Then, Step 308 tags the native machine code in permanent memory as a native machine code version of the application for use in the first machine environment. Step 312, in response to receiving a command to execute the application (Step 310), checks the permanent memory for a first machine environment native machine code version of the application. Then, accessing the native machine code from permanent memory in Step 314 includes accessing native machine code if a first machine environment native machine code version of the application is identified in permanent memory.

In one aspect of the method for example, receiving an application written in an intermediate code in Step 302 includes receiving an application written in JAVA. Then, compiling the intermediate code into native machine code in Step 304 includes using a just-in-time (JIT) JAVA virtual machine to compile the JAVA code into native machine code. Note that when other types of intermediate code are received, other corresponding types of virtual machines are used in the compilation.

In some aspects of the method, checking the permanent memory for a native machine code version of the application in Step 312 includes checking for the existence of application metadata associated with the native machine code version of the application. Then, the method includes further steps. Step 313a checks the integrity of the metadata. Step 313b, if the integrity check of the metadata fails, recompiles the intermediate code into native machine code. Step 313csaves the recompiled native machine code as a bundle in proximately located sections of permanent memory. Step 316 executes the recompiled native machine code version of the application.

In some aspects, checking the integrity of the metadata in Step 313a includes deleting associated executable (EXE) files, if the integrity check of the metadata fails. More specifically, checking the integrity of the metadata in Step 313 includes substeps. Step 313a1 checks that all the files, listed as required by the metadata, are present in permanent memory. Step 313a2, if any of the required files are missing, deletes any EXE files associated with the metadata. Step 313a3 checks that files, listed as required by the metadata, include a signature that matches the metadata signature. Step 313a4, if a non-matching signature is found, deletes any EXE files associated with the metadata. Step 313a5 checks the identifiers of hardware (HD) and software (SW) modules additionally required to execute the application. Step 313a6 checks that the unique identifier (UID) associated with the metadata is consistent with the hardware and/or software identifiers.

Some aspects of the method include further steps. Step 318 generates EXE files from the metadata. Step 320 checks the integrity of the EXE files. Step 322 updates the metadata to reflect the generated EXE files. Step 324 checks the integrity of the updated metadata. Step 326, if the integrity check of an updated metadata fails, deletes any associated EXE file.

Some aspects of the method include further steps. Step 328 receives a command to execute the application in a second machine environment, different than the first machine environment. Step 330 automatically recompiles the intermediate code into second machine environment native machine code. Step 332 executes the application using the second machine environment native machine code. Step 334 saves the second machine environment native machine code in permanent memory.

A system and method have been provided for more efficiently executing intermediate code. A few examples of intermediate code have been given, such as Java. However, the present invention is not limited to any particular type of intermediate code. An example process has also been described for checking and maintaining the integrity of the compiled native machine codes. An example was also presented for enabling the invention with machines sharing a memory. However, additional scenarios are possible. Other variations and embodiments of the invention will occur to those skilled in the art.

We claim:

1. A method for efficiently executing intermediate code, the method comprising:
receiving an application generated in an intermediate code;
automatically compiling the intermediate code into native machine code;
saving the native machine code in permanent memory;
receiving a command to execute the application;
accessing the native machine code from permanent memory; and,
executing the application using the native machine code.

2. The method of claim 1 wherein automatically compiling the intermediate code into native machine code includes compiling the intermediate code into a native machine code for a first machine environment;
wherein receiving a command to execute the application includes receiving a command to execute the application in the first machine environment; and,
wherein executing the application using the native machine code includes executing the application using the first machine environment native machine code.

3. The method of claim 2 further comprising:
receiving a command to execute the application in a second machine environment, different than the first machine environment;
automatically recompiling the intermediate code into second machine environment native machine code; and,
executing the application using the second machine environment native machine code.

4. The method of claim 3 further comprising:
saving the second machine environment native machine code in permanent memory.

5. The method of claim 1 wherein receiving an application generated in an intermediate code includes receiving the application in a first machine environment; and,
the method further comprising:
tagging the native machine code in permanent memory as a native machine code version of the application compiled for use in the first machine environment;
in response to receiving a command to execute the application, checking the permanent memory for a first machine environment native machine code version of the application; and,
wherein accessing native machine code from permanent memory includes accessing native machine code if a first machine environment native machine code version of the application is identified in permanent memory.

6. The method of claim 5 wherein receiving an application written in an intermediate code includes receiving an application written in an intermediate code language selected from the group including JAVA, .NET, and VisualBasic.

7. The method of claim 6 wherein receiving an application written in an intermediate code includes receiving an application written in JAVA; and,
wherein compiling the intermediate code into native machine code includes using a just-in-time (JIT) JAVA virtual machine to compile the JAVA code into native machine code.

8. The method of claim 5 wherein checking the permanent memory for a native machine code version of the application includes checking for the existence of application metadata associated with the native machine code version of the application; and,
the method further comprising:
checking the integrity of the metadata;
if the integrity check of the metadata fails, recompiling the intermediate code into native machine code; and,
wherein executing the application using the native machine code includes executing the recompiled native machine code version of the application.

9. The method of claim 8 wherein checking for the existence of application metadata associated with the native machine code version of the application includes checking metadata from a source selected from the group including metadata files, intermediate code files, and a metadata registry.

10. The method of claim 8 further comprising:
saving the recompiled native machine code as a bundle in proximately located sections of permanent memory.

11. The method of claim 10 wherein checking the integrity of the metadata includes deleting associated executable (EXE) files, if the integrity check of the metadata fails.

12. The method of claim 11 wherein checking the integrity of the metadata includes:
checking that all the files listed as required by the metadata are present in a memory; and,
if any of the required files are missing, deleting any EXE files associated with the metadata.

13. The method of claim 12 wherein checking the integrity of the metadata includes:
checking that files listed as required by the metadata include a signature that matches the metadata signature; and,
if a non-matching signature is found, deleting any EXE files associated with the metadata.

14. The method of claim 13 wherein checking the integrity of the metadata includes:
checking the identifiers of hardware and software modules additionally required to execute the application; and,
checking that the unique identifier (UID) associated with the metadata is consistent with hardware and software identifiers.

15. The method of claim 14 further comprising:
generating EXE files in response to the metadata;
checking the integrity of the EXE files;
updating the metadata to reflect the generated EXE files; and,
checking the integrity of the updated metadata.

16. The method of claim 15 further comprising:
if the integrity check of an updated metadata fails, deleting any associated EXE file.

17. The method of claim 1 wherein accessing native machine code from permanent memory includes accessing a permanent memory selected from the group including FLASH, hard drive, EEPROM, and removable drives.

18. A system for efficiently executing intermediate code, the system comprising:
a first memory having an interface to receive an application that has been generated in an intermediate code;
a virtual machine having an interface to accept the intermediate code application from the first memory and compile the intermediate code into native machine code;
a permanent memory having an interface connected to the virtual machine to save the native machine code; and,
a processor having a user interface to receive a command to execute the application, the processor accessing native machine code from the permanent memory and executing the application using the native machine code.

19. The system of claim 18 wherein the processor is a first machine environment processor; and,
wherein the virtual machine compiles the intermediate code into a first machine environment native machine code of the application.

20. The system of claim 19 wherein the permanent memory accepts a tagged first machine environment native machine code version of the application; and,
wherein the first machine environment processor, in response to receiving a command to execute the application, checks the permanent memory for a first machine environment native machine code version of the application and accesses the permanent memory if a first machine environment native machine code version of the application is identified in permanent memory.

21. The system of claim 20 wherein the first memory receives an application written in an intermediate code language selected from the group including JAVA, .NET, and VisualBasic.

22. The system of claim 20 wherein the first memory receives an application written in JAVA; and,
wherein the virtual machine is a just-in-time (JIT) JAVA virtual machine to compile the JAVA code into native machine code.

23. The system of claim 20 wherein the processor checks permanent memory for the existence of application metadata associated with the native machine code version of the application, and checks the integrity of the metadata;
wherein the virtual machine recompiles the intermediate code into native machine code if the integrity check of the metadata fails; and,
wherein the processor executes the recompiled native machine code version of the application.

24. The system of claim 23 wherein the processor checks for the existence of metadata in a source selected from the group including metadata files, intermediate code files, and a metadata registry.

25. The system of claim 24 wherein the virtual machine saves the recompiled native machine code as a bundle in proximately located sections of permanent memory.

26. The system of claim 25 wherein the processor deletes associated executable (EXE) files in permanent memory, if the integrity check of the metadata fails.

27. The system of claim 26 wherein the processor checks that all the files listed as required by the metadata are present in permanent memory, and if any of the required files are missing, deletes any EXE files in permanent memory associated with the metadata.

28. The system of claim 27 wherein the processor checks that files listed as required by the metadata include a signature that matches the metadata signature, and if a non-matching signature is found, deletes any EXE files in permanent memory associated with the metadata.

29. The system of claim 28 further comprising:
a second memory including software, with a software identifier, required by the processor to perform the application; and,
a hardware module with a hardware identifier required by the processor to perform the application; and,
wherein the processor checks that the unique identifier (UID) associated with the metadata in permanent memory is consistent with the hardware and software identifiers.

30. The system of claim 29 wherein the processor generates EXE files from the metadata, checks the integrity of the EXE files, updates the metadata in permanent memory to reflect the generated EXE files, and checks the integrity of the updated metadata.

31. The system of claim 30 wherein the processor deletes any associated EXE file in permanent memory if the integrity check of the metadata fails.

32. The system of claim 18 wherein the permanent memory is selected from the group including FLASH, hard drive, EEPROM, and removable drives.

33. A system for efficiently executing intermediate code, the system comprising:
a first machine environment including:
a first memory having an interface to receive an application that has been generated in an intermediate code;
a virtual machine having an interface to accept the intermediate code application from the first memory and compile the intermediate code into a first machine environment native machine code;
a permanent memory having an interface connected to the virtual machine to save the first machine environment native machine code; and,
a processor having a user interface to receive a command to execute the application, the processor accessing first machine environment native machine code from the permanent memory and executing the application using the first machine environment native machine code; and,
a second machine environment including:
a virtual machine having an interface for accepting the intermediate code application from the first memory and recompiling the intermediate code into a second machine environment native machine code;
a permanent memory having an interface connected to the virtual machine to save the second machine environment native machine code; and,
a processor having a user interface to receive a command to execute the application, the processor accessing second machine environment native machine code from the permanent memory and executing the application using the second machine environment native machine code.
